(19) United States
(12) Patent Application Publication
(10) Pub. No.: US 2024/0309843 A1
(43) Pub. Date: Sep. 19, 2024

(54) COOPERATIVE OPERATION OPTIMIZATION CONTROL METHOD FOR WIND TURBINE GROUPS

(71) Applicant: North China Electric Power University, Beijing (CN)

(72) Inventors: Yang Hu, Beijing (CN); Fang Fang, Beijing (CN); Chong ZHANG, Beijing (CN); Jizhen Liu, Beijing (CN)

(21) Appl. No.: 18/608,645

(22) Filed: Mar. 18, 2024

(30) Foreign Application Priority Data
Mar. 17, 2023 (CN) 202310262107.2

(51) Int. Cl. F03D 7/04

(52) U.S. Cl. CPC F03D 7/049; F05B 2260/84; F05B 2270/204

(57) ABSTRACT

A cooperative operation optimization control method for wind turbine groups, including: dividing wind turbine groups based on a digital model and an improved Jensen wake model; performing multi-degree-of-freedom controller design on wind turbines; calculating an ultimate load of the wind turbines jointly by using two methods, and constructing a safe load constraint and a yaw angle constraint for wind turbine operation in conjunction with a safe load coefficient; establishing a collaborative optimization problem model of the wind turbine groups by taking the maximum generating power of the wind turbine groups as an optimization objective, a yaw angle of an upstream wind turbine as a decision variable, and the safe load constraint, the yaw angle constraint and a power change range of the upstream wind turbine as constraint conditions; and determining a cooperative operation optimization algorithm for the wind turbine groups, and optimizing the yaw angle of the wind turbines.

### TECHNICAL FIELD

The present invention relates to the technical field of wind power control, and in particular to a cooperative operation optimization control method for wind turbine groups.

### BACKGROUND

In recent years, wind power generation has rapidly developed. In China, it has been clearly pointed out that, by 2030, China's carbon dioxide emissions per unit of gross domestic product will be reduced by more than 65% compared with 2005, non-fossil energy will account for about 25% of primary energy consumption, and the total installed capacity of wind power, solar power generation will reach more than 1.2 billion kilowatts. Wind power generation generally exists in the form of wind turbine groups. In order to ensure the safe operation of wind turbine groups, improve the power generating efficiency of wind turbine groups and wind resource utilization rate, studying the control optimization of wind turbine groups during operation has an important theoretical value and practical significance.

### SUMMARY

In order to overcome the defects existing in the prior art, the object of the present invention is to provide a cooperative operation optimization control method for wind turbine groups.

In order to achieve the above object, the present invention provides the following scheme:

A cooperative operation optimization control method for wind turbine groups, including:

establishing a digital model of wind turbine groups to be measured, establishing a wake influence matrix according to the digital model and an improved Jensen wake model, and dividing the wind turbine groups according to the wake influence matrix to obtain divided wind turbines;

performing multi-degree-of-freedom controller design on the wind turbines;

calculating an ultimate load of the wind turbines jointly by using two methods, i.e. Extrapolation and Mextremes, and constructing a safe load constraint and a yaw angle constraint for wind turbine operation in conjunction with a safe load coefficient;

establishing a collaborative optimization problem model of the wind turbine groups by taking the maximum generating power of the wind turbine groups as an optimization objective, a yaw angle of an upstream wind turbine as a decision variable, and the safe load constraint, the yaw angle constraint and a power change range of the upstream wind turbine as constraint conditions; and

based on a pattern search method, determining a cooperative operation optimization algorithm for the wind turbine groups according to the cooperative optimization problem model of the wind turbine groups, and optimizing the yaw angle of the wind turbines according to the cooperative operation optimization algorithm for the wind turbine groups, so as to achieve the maximum power generating capacity.

Preferably, the establishing a digital model of wind turbine groups to be measured, establishing a wake influence matrix according to the digital model and an improved Jensen wake model, and dividing the wind turbine groups according to the wake influence matrix to obtain divided wind turbines includes:

establishing the digital model according to the group information of the wind turbine groups to be measured;

based on Turbsim, determining relative position information of all wind turbines according to the digital model;

re-adjusting a wake decay constant in Jensen according to the wind speed of a downstream wind turbine that is actually measured to obtain the improved Jensen wake model, the calculation formula of the improved Jensen wake model being:

$$\\ k = ( \sqrt{\frac{{u}_{0} ( 1 - \sqrt{1 - {C}_{T , n}} )}{{u}_{0} - {u}_{n}}} - 1 ) / 2 s ;$$

$$\\ {D}_{w , n} = D ( 1 + ( \sqrt{\frac{{u}_{0} ( 1 - \sqrt{1 - {C}_{T , n}} )}{{u}_{0} - {u}_{n}}} - 1 ) ) ;$$

where D_{W,n} is the wake diameter at a distance s times the wind rotor diameter downstream of a wind turbine n; k is the adjusted wake decay constant; D is the wind rotor diameter; uₙ is the wake wind speed at a distance s times the wind rotor diameter downstream of the wind turbine n; u₀ is the incoming wind speed at infinity; and C_{T,n} is a thrust coefficient of the wind turbine n;

inputting the relative position information into the improved Jensen wake model to obtain high-precision wind turbine group wake information;

obtaining a wake field effect determinant according to the high-precision wind turbine group wake information and blade radius information of upstream and downstream wind turbines, the wake field effect determinant being

$$\\ {w}_{ij} = \{ \begin{matrix}\frac{( \frac{π ( α {r}_{1}^{{}_{} 2} + θ {r}_{2}^{{}_{} 2} )}{180} - {r}_{1} d sin α )}{π {r}_{2}^{{}_{} 2}} , & Wake overlap \\ 0 , & i = j \\ 0 , & No wake overlap\end{matrix} ;$$

where wᵢⱼ is the degree of wake influence of a wind turbine i on a wind turbine j, r₁ is the wake radius, r₂ is the radius of the wind rotor of a downstream wind turbine, d is the distance from the center of the wake circle to the center of the wind rotor circle, α is the included angle between a connecting line between the point where a wake region and the wind rotor intersect and the center of the wake circle and d, and θ is the included angle between the connecting line between the point where the wake region and the wind rotor intersect and the center of the wind rotor circle and d; and

establishing a wake influence matrix of the wind turbine groups according to the wake field effect determinant, calculating the degree of wake effect influence of the wind turbine groups according to the wake influence matrix of the wind turbine groups, and dividing the wind turbine groups according to the degree of wake effect influence to obtain divided wind turbines.

Preferably, the performing multi-degree-of-freedom controller design on the wind turbines includes:

establishing a variable pitch controller through a gain scheduling control strategy;

designing a generator torque controller through a variable speed torque partition control strategy; and

controlling the wind turbine according to the variable pitch controller and the generator torque controller;

the calculation formulae of the variable pitch controller being:

$$\\ {K}_{P} = \frac{2 {I}_{Drivertrain} {}_{} {Ω}_{0} {}_{} {ζ}_{φ} {w}_{φ n}}{{N}_{Gear} [ - \frac{\partial P}{\partial θ} ]} GK ( θ ) ; {K}_{I} = \frac{{I}_{Drivertrain} {}_{} {Ω}_{0} {w}_{φ n}^{{}_{} 2}}{{N}_{Gear} [ - \frac{\partial P}{\partial θ} ]} GK ( θ ) ;$$

$$\\ GK ( θ ) = \frac{1}{1 + \frac{θ}{{θ}_{K}}} ;$$

where IDᵣᵢᵥₑᵣₜᵣₐᵢₙ is the drive train inertia on a low-speed shaft; Ω0 is the rated low-speed shaft rotating speed; ζ^{φ} is the damping ratio; W^{φn} is the intrinsic frequency; N_{Gear} is the ratio of a high-speed gearbox to a low-speed gearbox; P is the mechanical power; θ is the total blade variable pitch angle of a full-span rotor; θ_{K} is the blade variable pitch angle; GK(θ) is the dimensionless gain correction factor; K_{P} is the proportional gain of the variable pitch controller; and K_{I} is the integral gain of the variable pitch controller;

a control region of the generator torque controller includes: a first region, a second region, a third region, a fourth region and a fifth region; the first region is a control region prior to cutting into the wind speed, where the generator torque is zero and no power is extracted from the wind; the second region is a start-up region and is a linear transition between the first region and the third region; the third region is a control region used to optimize power capture, where the generator torque is proportional to the square of the filtered generator speed to maintain a constant tip speed ratio; the fourth region is a linear transition between the third region and the fifth region, where a torque slope corresponds to the slope of an induction motor; and the generator power in the fifth region remains constant, and the generator torque is inversely proportional to the filtered generator rotating speed.

Preferably, the calculating an ultimate load of the wind turbines jointly by using two methods, i.e. Extrapolation and Mextremes, and constructing a safe load constraint and a yaw angle constraint for wind turbine operation in conjunction with a safe load coefficient includes:

directly integrating short-term load exceeding probabilities at different wind speeds to obtain a long-term load exceeding probability of the wind turbines, dividing a wind speed interval of a preset working condition into multiple sub-intervals in accordance with the resolution of a preset speed according to a preset standard, and within each sub-interval, performing yaw control on the wind turbines at a speed below the rated wind speed, and performing yaw control and pitch angle control simultaneously on the wind turbines at a speed above the rated wind speed;

dividing operation data of the wind turbines into multiple working conditions according to the wind speed, performing multiple random simulations on each working condition under the same operation condition, and inputting each set of simulation data into Mextremes to obtain the ultimate load and corresponding wind speed;

determining the safe load constraint according to the values of the ultimate load and a preset local load safety coefficient; and

searching for a starting yaw angle through the opposite wind direction under a preset working condition to obtain corresponding loads of the wind turbines under different yaw angle and wind speed conditions, and taking a threshold value of the yaw angle using the safe load constraint to obtain the corresponding yaw angle constraint.

Preferably, the expressions of the optimization objective and the constraint conditions are:

$$\\ Max {P}_{farm} ; \{ \begin{matrix}{L}_{Root} < {L}_{Safe , r} \\ {L}_{Yaw} < {L}_{Safe , y} \\ {L}_{Twr} < {L}_{Safe , t} \\ {Y}_{c} < {Y}_{L} \\ △ {P}_{up} < 3 \%\end{matrix} ;$$

where P_{farm} and Pᵤₚ are the generating power of the wind turbine groups and the power of the upstream wind turbine, respectively; L_{Root}, L_{Yaw} and L_{Twr} are the wind turbine blade root out-of-plane moment, yaw bearing moment and tower base pitching moment, respectively; L_{safe,r}, L_{safe,y} and L_{safe,t} are the obtained safe load limits, respectively; Y_{c} and Y_{L} are the real-time yaw angle of the upstream wind turbine and the obtained yaw constraint; and ΔPᵤₚ is the power change value of the upstream wind turbine.

Preferably, the based on a pattern search method, determining a cooperative operation optimization algorithm for the wind turbine groups according to the cooperative optimization problem model of the wind turbine groups, and optimizing the yaw angle of the wind turbines according to the cooperative operation optimization algorithm for the wind turbine groups, so as to achieve the maximum power generating capacity includes:

when performing collaborative optimization on the wind turbine groups, sorting the wind turbine groups according to the wind direction, dividing into optimized wind turbines T₁-Tₙ, selecting upstream and downstream wind turbines Tᵢ and Tᵢ+₁ in sequence, and optimizing the yaw angle of the upstream wind turbine through the pattern search method, thereby realizing the rolling optimization of the yaw angle of the wind turbine groups; the optimization steps of the pattern search method being as follows:
1) initializing the yaw angle of the upstream wind turbine as y₁, the initial step size as s, the direction coefficient α>1, the shortening factor β∈(0, 1), and the error as ε, and assuming x₁=y₁, k=1, j=1;
2) reading the simulation model information to calculate P_{farm}(yⱼ+αs), if P_{farm}(yⱼ+αs)>P_{farm}(yⱼ), assuming yⱼ₊₁=yⱼ+αs and xₖ=yⱼ₊₁, skipping to step 4); and if _{Pfarm}(yⱼ+αs)≤P_{farm}(yⱼ), skipping to step 3);
3) if P_{farm}(yⱼ−αs)>P_{farm}(yⱼ), assuming yⱼ₊₁=yⱼ−αs and xₖ=yⱼ₊₁; otherwise, assuming yⱼ₊₁=yⱼ, and skipping to step 4); and
4) if the step size sse, exiting the calculation, and obtaining the optimal solution of the objective function; otherwise, assuming s=s*β, y₁=xₖ, k=k+1, j=1, and skipping to step 2).

According to specific embodiments provided by the present invention, the present invention discloses the following technical effects:

In the present invention, a cooperative operation optimization strategy for wind turbine groups is proposed. Active wake control among wind turbines is studied, a yaw control instruction is issued to the upstream wind turbine through real-time communication between wind turbines, the state advantage of the wind turbines is dynamically adjusted to dynamically adjust the operation state of the wind turbines, the wind turbine power is deeply trapped to increase potential, and the overall power generating efficiency of multiple wind turbines as well as the utilization rate of wind resources are effectively improved. The safe load range of the wind turbines is comprehensively determined in conjunction with the two extreme load calculation methods, i.e. Extrapolation and Mextremes and the preset safe load coefficient, and the safe yaw angle limit of the wind turbines is determined accordingly, thereby improving the wind turbine operation safety. A wake influence matrix of the wind turbine groups is established by means of the proposed inverse iterative optimization method for improved Jensen model parameters, and by analyzing the wake overlap area between wind turbines, in conjunction with the operation state of the wind turbines, it is jointly judged whether to start an operation optimization process, thereby preventing frequently invoking a yaw motor, and improving the wind turbine operation stability.

### BRIEF DESCRIPTION OF DRAWINGS

In order to more clearly illustrate the technical schemes in the embodiments of the present invention or in the prior art, the accompanying drawings to be used in the embodiments will be briefly described below. Obviously, the accompanying drawings in the following description are only part of embodiments in the present invention, and a person of ordinary skill in the art may also obtain other accompanying drawings based on these accompanying drawings without creative effort.

FIG. 1 is a flowchart of a method provided in an embodiment of the present invention;

FIG. 2 is a schematic diagram of a collaborative operation optimization control process provided in an embodiment of the present invention;

FIG. 3 is a schematic diagram of an improved Jensen wake model provided in an embodiment of the present invention;

FIG. 4 is a schematic diagram of a wake overlap area provided in an embodiment of the present invention; and

FIG. 5 is a schematic diagram of a variable speed torque partition control strategy for wind turbines provided in an embodiment of the present invention.

### DETAILED DESCRIPTION OF EMBODIMENTS

The technical schemes in the embodiments of the present invention will be clearly and completely described as below in conjunction with the accompanying drawings in the embodiments of the present invention. Obviously, the described embodiments are only a part of, not all of, the embodiments of the present invention. All other embodiments obtained by a person of ordinary skill in the art based on the embodiments of the present invention without creative effort shall fall into the scope of protection of the present invention.

An object of the present invention is to provide a cooperative operation optimization control method for wind turbine groups, and the overall power generating efficiency of multiple wind turbines and the utilization rate of wind resources can be improved.

In order to make the above objects, features and advantages of the present invention more apparent and understandable, the present invention will be further described in detail below in conjunction with the accompanying drawings and specific embodiments.

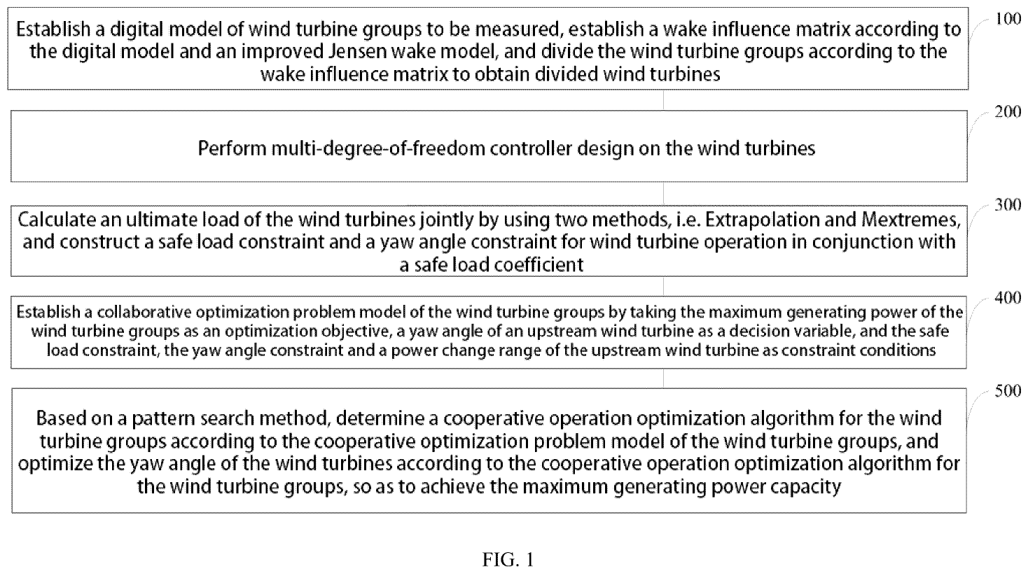

FIG. 1 is a flowchart of a method provided in an embodiment of the present invention. As shown in FIG. 1, the present invention provides a collaborative operation optimization control method for wind turbine groups, including:
Step 100: establish a digital model of wind turbine groups to be measured, establish a wake influence matrix according to the digital model and an improved Jensen wake model, and divide the wind turbine groups according to the wake influence matrix to obtain divided wind turbines;
Step 200: perform multi-degree-of-freedom controller design on the wind turbines;
Step 300: calculate an ultimate load of the wind turbines jointly by using two methods, i.e. Extrapolation and Mextremes, and construct a safe load constraint and a yaw angle constraint for wind turbine operation in conjunction with a safe load coefficient;
Step 400: establish a collaborative optimization problem model of the wind turbine groups by taking the maximum generating power of the wind turbine groups as an optimization objective, a yaw angle of an upstream wind turbine as a decision variable, and the safe load constraint, the yaw angle constraint and a power change range of the upstream wind turbine as constraint conditions; and
Step 500: based on a pattern search method, determine a cooperative operation optimization algorithm for the wind turbine groups according to the cooperative optimization problem model of the wind turbine groups, and optimize the yaw angle of the wind turbines according to the cooperative operation optimization algorithm for the wind turbine groups, so as to achieve the maximum power generating capacity.

Preferably, the establishing a digital model of wind turbine groups to be measured, establishing a wake influence matrix according to the digital model and an improved Jensen wake model, and dividing the wind turbine group according to wake influence matrix to obtain divided wind turbines includes:

establishing the digital model according to the group information of the wind turbine groups to be measured;

based on Turbsim, determining relative position information of all wind turbines according to the digital model;

re-adjusting a wake decay constant in Jensen according to the wind speed of a downstream wind turbine that is actually measured to obtain the improved Jensen wake model, the calculation formula of the improved Jensen wake model

$$\\ k = ( \sqrt{\frac{{u}_{0} ( 1 - \sqrt{1 - {C}_{T , n}} )}{{u}_{0} - {u}_{n}}} - 1 ) / 2 s ;$$

$$\\ {D}_{w , n} = D ( 1 + ( \sqrt{\frac{{u}_{0} ( 1 - \sqrt{1 - {C}_{T , n}} )}{{u}_{0} - {u}_{n}}} - 1 ) ) ;$$

where D_{W,n} is the wake diameter at a distance s times the wind rotor diameter downstream of a wind turbine n; k is the adjusted wake decay constant; D is the wind rotor diameter; un is the wake wind speed at a distance s times the wind rotor diameter downstream of the wind turbine n; uo is the incoming wind speed at infinity; and C_{T,n} is the thrust coefficient of the wind turbine n;

inputting the relative position information into the improved Jensen wake model to obtain high-precision wind turbine group wake information;

obtaining a wake field effect determinant according to the high-precision wind turbine group wake information and blade radius information of upstream and downstream wind turbines, the wake field effect determinant being

$$\\ {w}_{ij} = \{ \begin{matrix}\frac{( \frac{π ( α {r}_{1}^{{}_{} 2} + θ {r}_{2}^{{}_{} 2} )}{180} - {r}_{1} d sin α )}{π {r}_{2}^{{}_{} 2}} , & Wake overlap \\ 0 , & i = j \\ 0 , & No wake overlap\end{matrix} ;$$

where wᵢⱼ is the degree of wake influence of a wind turbine i on a wind turbine j, r₁ is the wake radius, r₂ is the radius of the wind rotor of a downstream wind turbine, d is the distance from the center of the wake circle to the center of the wind rotor circle, α is the included angle between a connecting line between the point where a wake region and the wind rotor intersect and the center of the wake circle to d, and θ is the included angle between the connecting line between the point where the wake region and the wind rotor intersect and the center of the wind rotor circle and d; and

establishing a wake influence matrix of the wind turbine groups according to the wake field effect determinant, calculating the degree of wake effect influence of the wind turbine groups according to the wake influence matrix of the wind turbine groups, and dividing the wind turbine groups according to the degree of wake effect influence to obtain divided wind turbines.

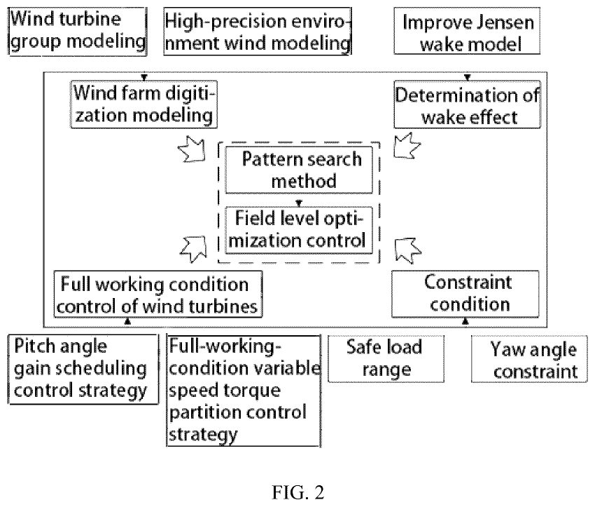

Specifically, as shown in FIG. 2, the cooperative operation optimization control process for wind turbine groups with both wake control and energy efficiency improvement provided in this embodiment is as follows:
(1) digitally modeling the wind turbine groups based on the actual wind turbine longitude and latitude, altitude, wind turbine structure, model and other information, generating high-precision environmental wind data using Turbsim, calculating through the improved Jensen wake model to obtain wind turbine wake model information, dividing the wind turbine groups based on the wake influence, and establishing a wake influence matrix of the wind turbine groups;
(2) performing multi-degree-of-freedom controller design on the wind turbines, designing a variable pitch controller based on a gain scheduling control strategy, and designing a generator torque controller based on a variable speed torque partition control strategy;
(3) calculating an ultimate load of the wind turbines jointly by using two methods, i.e. Extrapolation and Mextremes, and constructing an establishment mechanism for the safe load constraint and yaw angle constraint for wind turbine operation in conjunction with the safe load coefficient;
(4) establishing a cooperative optimization problem model of the wind turbine groups by taking the maximum generating power of the wind turbine groups as an optimization objective, a yaw angle of an upstream wind turbine as a decision variable, and the safe load constraint, the yaw constraint and a power change range of the upstream wind turbine as constraint conditions; and
(5) according to the established optimization model, designing a cooperative operation optimization algorithm for the wind turbine groups based on a pattern search method, and optimizing the yaw angle of the divided wind turbines, so as to achieve the maximum power generating capacity.

Specifically, in this embodiment, wind turbine information including wind speed in front of upstream and downstream wind turbines, wind turbine latitude and longitude, altitude, blade radii of the upstream and downstream wind turbines, etc. is acquired; a wind turbine group model is established according to the acquired information, high-precision environmental wind data is generated using Turbsim, wake diameter and wake wind speed of the upstream wind turbine and other information are obtained through the improved Jensen wake calculation model, and the wind turbine groups are divided accordingly to synchronously construct a wake influence matrix of the wind turbine groups. The main steps are as follows:

First, the relative position information of wind turbines is input into the improved Jensen wake calculation model. An upstream wind turbine and a downstream wind turbine are taken for example. The calculation formula of the traditional Jensen wake model is as follows.

$$\\ {D}_{w , n} = D ( 1 + 2 ks )$$

$$\\ {u}_{n} = {u}_{0} [ 1 - \frac{1 - \sqrt{1 - {C}_{T , n}}}{{( 1 + 2 ks )}^{2}} ]$$

In the formulae, D_{W,n} is the wake diameter at a distance s times the wind rotor diameter downstream of a wind turbine n; k is the wake decay constant; D is the wind rotor diameter; uₙ is the wake wind speed at a distance s times the wind rotor diameter downstream of the wind turbine n; u₀ is the incoming wind speed at infinity; and C_{T,n} is the thrust coefficient of the wind turbine n.

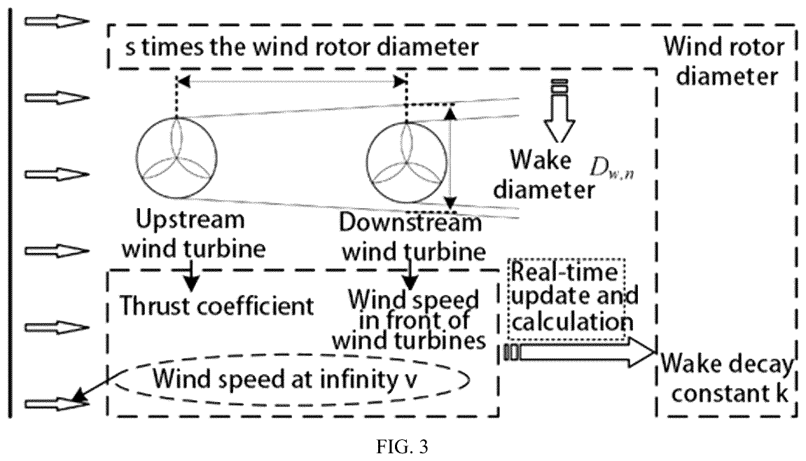

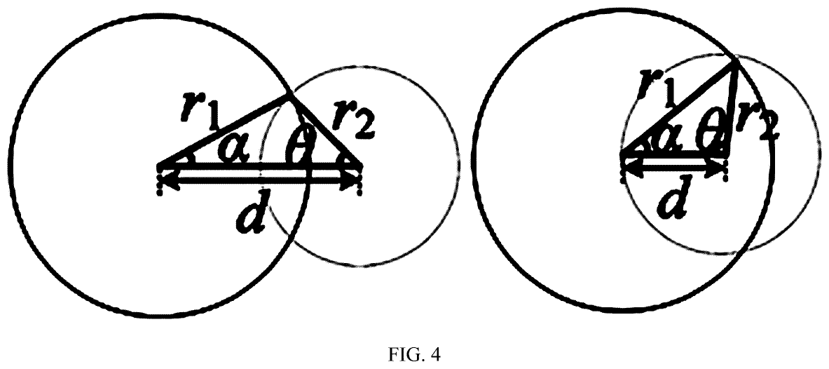

A wake decay constant in Jensen is re-adjusted according to the wind speed of the downstream wind turbine that is actually measured, as shown in FIGS. 3 and 4, to obtain the calculation formula of D_{W,n} in the improved Jensen wake model as follows:

$$\\ k = ( \sqrt{\frac{{u}_{0} ( 1 - \sqrt{1 - {C}_{T , n}} )}{{u}_{0} - {u}_{n}}} - 1 ) / 2 s$$

$$\\ {D}_{w , n} = D ( 1 + ( \sqrt{\frac{{u}_{0} ( 1 - \sqrt{1 - {C}_{T , n}} )}{{u}_{0} - {u}_{n}}} - 1 ) )$$

Then, a wake field effect determinant is obtained according to the calculated high-precision wind turbine group wake information and blade radius information of the upstream and downstream wind turbines, the wake field effect determinant being shown as follows:

$${w}_{ij} = \{ \begin{matrix}\frac{( \frac{π ( {ar}_{1}^{2} + θ {r}_{2}^{2}}{180} r , d sin α )}{π {r}_{2}^{3}} , & Wake overlap \\ 0 , & i - j \\ 0 , & No wake overlap\end{matrix} ;$$

Finally a wake influence matrix of the wind turbine groups is established according to the wake field effect determinant, the degree of wake effect influence of the wind turbine groups is calculated, and it is judged whether to perform collaborative optimization on the wind turbine groups on this basis.

Preferably, the performing multi-degree-of-freedom controller design on the wind turbines includes:

establishing a variable pitch controller through a gain scheduling control strategy;

designing a generator torque controller through a variable speed torque partition control strategy; and

controlling the wind turbines according to the variable pitch controller and the generator torque controller;

the calculation formulae of the variable pitch controller being

$${K}_{P} = \frac{2 {I}_{Drivetrain} {Ω}_{0} {ζ}_{φ} {w}_{φ rt}}{{N}_{Gear} [ - \frac{\partial P}{\partial θ} ]} GK ( θ ) ;$$

$${K}_{I} = \frac{{I}_{Drivetrain} {Ω}_{0} \text{?}}{{N}_{Gear} [ - \frac{\partial P}{\partial θ} ]} GK ( θ ) ;$$

$$GK ( θ ) = \frac{1}{1 + \frac{θ}{{θ}_{K}}} ;$$

$$\text{?} \text{indicates text missing or illegible when filed}$$

where IDᵣᵢᵥₑᵣₜᵣₐᵢₙ is the drive train inertia on a low-speed shaft; Ω₀ is the rated low-speed shaft rotating speed; ζ_{φ} is the damping ratio; W_{φn} is the natural frequency; N_{Gear} is the ratio of a high-speed gearbox to a low-speed gearbox; P is the mechanical power; θ is the total blade variable pitch angle of a full-span rotor; θ_{K} is the blade variable pitch angle; GK(θ) is the dimensionless gain correction factor; K_{P} is the proportional gain of the variable pitch controller; and K₁ is the integral gain of the variable pitch controller;

A control region of the generator torque controller includes: a first region, a second region, a third region, a fourth region and a fifth region; the first region is a control region prior to cutting into the wind speed, where the generator torque is zero and no power is extracted from the wind; the second region is a start-up region and is a linear transition between the first region and the third region; the third region is a control region used to optimize power capture, where the generator torque is proportional to the square of the filtered generator speed to maintain a constant tip speed ratio; the fourth region is a linear transition between the third region and the fifth region, where a torque slope corresponds to the slope of an induction motor; and the generator power in the fifth region remains constant, and the generator torque is inversely proportional to the filtered generator rotating speed.

Further, in this embodiment, a generator torque controller is designed through a variable speed torque partition control strategy. The main steps are as follows:

With regard to a variable pitch controller: a total blade variable pitch angle instruction of a full-span rotor is calculated by performing predetermined proportional integral control on the speed error between the filtered generator rotating speed and the rated generator rotating speed. To improve the control performance of the controller, a gain scheduling PI controller is used to adjust the proportional gain K_{P} and integral gain K_{I} of the controller. The calculation methods for the two gains are as follows:

$${K}_{P} = \frac{2 {I}_{Drivetrain} {Ω}_{0} {ζ}_{φ} {w}_{φ rt}}{{N}_{Gear} [ - \frac{\partial P}{\partial θ} ]} GK ( θ )$$

$${K}_{I} = \frac{{I}_{Drivetrain} {Ω}_{0} \text{?}}{{N}_{Gear} [ - \frac{\partial P}{\partial θ} ]} GK ( θ )$$

$$GK ( θ ) = \frac{1}{1 + \frac{θ}{{θ}_{K}}}$$

$$\text{?} \text{indicates text missing or illegible when filed}$$

In the formulae, I_{Drivertrain} is the drive train inertia on a low-speed shaft; Ω₀ is the rated low-speed shaft rotating speed; ζ_{φ} is the damping ratio; W_{φn} is the natural frequency; N_{Gear} is the ratio of a high-speed gearbox to a low-speed gearbox; P is mechanical power; θ is the total blade variable pitch angle of a full-span rotor; θ_{K} is the blade variable pitch angle; and GK(θ) is the dimensionless gain correction factor.

During the actual simulation calculation process, a blade variable pitch angle of the previous controller time step is used to calculate a gain correction coefficient of the next time step. For actual parameter scenarios, the initial gain coefficient of the control algorithm can be optimized, and the variable pitch rate can be designed according to the actual operation condition of the wind turbines.

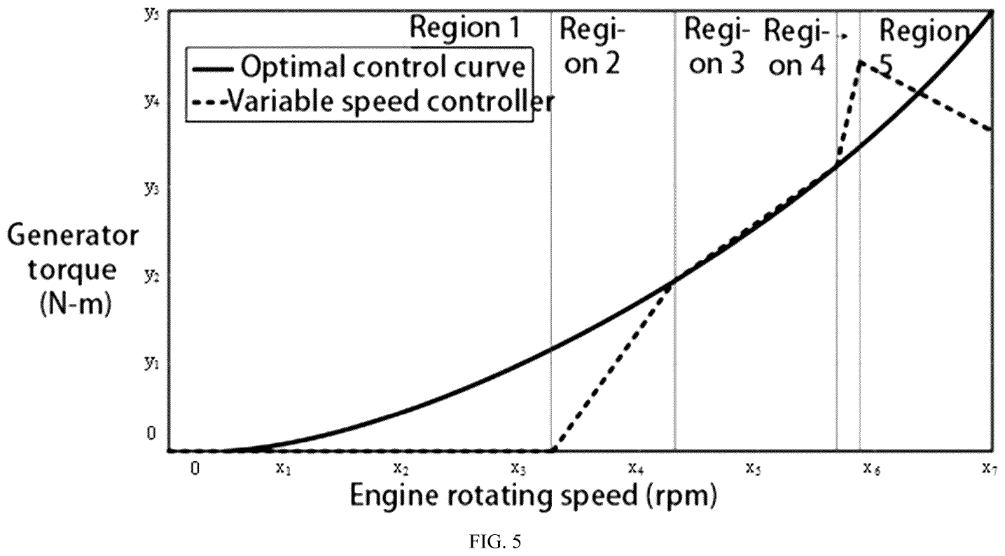

With regard to a generator torque controller: the generator torque is calculated as a table function of the filtered generator rotating speed, including five control regions: the first region is a control area prior to cutting into the wind speed, where the generator torque is zero and no power is extracted from the wind; the third region is a control region used to optimize power capture, where the generator torque is proportional to the square of the filtered generator speed to maintain a constant (optimal) tip speed ratio; in the fifth region, the generator power is kept constant, and thus the generator torque is inversely proportional to the filtered generator rotating speed; the second region is a start-up region and is a linear transition between the first region and the third region, and is used to set a lower limit of the generator speed to limit the operation speed range of the wind turbines; the fourth region is a linear transition between the third region and the fifth region, where a torque slope corresponds to the slope of an induction motor. Typically, the fourth region is required to limit the tip speed at the rated power. The distribution of each region is shown in FIG. 5.

Preferably, the calculating an ultimate load of the wind turbines jointly by using two methods, i.e. Extrapolation and Mextremes, and constructing a safe load constraint and a yaw angle constraint for wind turbine operation in conjunction with a safe load coefficient includes:

directly integrating short-term load exceeding probabilities at different wind speeds to obtain a long-term load exceeding probability of the wind turbines, dividing a wind speed interval of a preset working condition into multiple sub-intervals in accordance with the resolution of a preset speed according to a preset criterion, and within each sub-interval, performing yaw control on the wind turbines at a speed below the rated wind speed, and performing yaw control and pitch angle control simultaneously on the wind turbines at a speed above the rated wind speed;

dividing operation data of the wind turbines into multiple working conditions according to the wind speed, performing multiple random simulations on each working condition under the same operation condition, inputting each set of simulation data into Mextremes to obtain the ultimate load and corresponding wind speed;

determining the safe load constraint according to the values of the ultimate load and a preset local load safety coefficient; and

searching for a starting yaw angle through the opposite wind direction under a preset working condition to obtain corresponding loads of the wind turbines under different yaw angle and wind speed conditions, and taking a threshold value of the yaw angle using the safe load constraint to obtain the corresponding yaw angle constraint.

Further, the steps of calculating the ultimate load by using Extrapolation and Mextremes in this embodiment are as follows:

With regard to Extrapolation: short-term load exceeding probabilities P_{T}at different wind speeds are directly integrated to obtain a long-term load exceeding probability of the wind turbine. A wind speed interval required for a working condition DLC1.1 is divided into 11 sub-intervals in accordance with the resolution of 2 m/s according to the minimum standard required by IEC, with each sub-interval being a short-term operation interval. Within each sub-interval, yaw control is performed on the wind turbines at a speed below the rated wind speed, and yaw control and pitch angle control are performed simultaneously on the wind turbines at a speed above the rated wind speed.

For each sub-interval, the extreme values are taken in chunks, each short-term operation result is divided into 30 chunks by using a Gumbel distribution maximum likelihood method, so that an array M containing 30 n maximum values can be obtained for n sub-intervals, the array M can be fitted by using Gumbel distribution, and then according to the exceeding probability of the wind turbine, the ultimate load under the recurrence of T years can be obtained.

With regard to Mextremes: the operation data are divided into n working conditions according to the wind speed, m random simulations are performed on each working condition under the same operation condition, and n*m sets of simulation data are input into Mextremes to obtain the ultimate load and corresponding wind speed.

Further, the mechanism for constructing the establishment mechanism for the safe load constraint and yaw angle constraint for wind turbine operation is as follows:

According to the provisions of IEC61400-1 for load safety coefficients, for the operation condition corresponding to the working condition DLC1.1, the local load safety coefficient γf=1.25 under normal design conditions. The numerical product of the smaller value of the ultimate load of the wind turbines obtained through the joint calculation and verification of Extrapolation and Mextremes and the local load safety coefficient is taken as the safe load constraint.

Under the working condition of IEC64100-1 DLC1.1, the starting yaw angle through the opposite wind direction is searched to obtain corresponding loads of the wind turbines under different yaw angle and wind speed conditions, and a threshold value of the yaw angle is taken using the safe load constraint to obtain the corresponding yaw angle constraint.

Preferably, the expressions of the optimization objective and the constraints are:

$$Max {Pf}_{arm ;}$$

$$\{ \begin{matrix}{L}_{Root} < {L}_{Safe , r} \\ {L}_{Yaw} < {L}_{Safe , y} \\ {L}_{Twr} < {L}_{Safe , t} \\ {Y}_{c} < {Y}_{L} \\ △ {P}_{up} < 3 \%\end{matrix} ;$$

where P_{farm}and Pᵤₚ are the generating power of the wind turbine groups and the power of the upstream wind turbine, respectively; L_{Root}, L_{Yaw} and L_{Twr} are the wind turbine blade root out-of-plane moment, yaw bearing moment and tower base pitching moment, respectively; L_{safe,r}, L_{safe,y} and L_{safe,t} are the obtained safe load limits, respectively; Y_{c} and Y_{L} are the real-time yaw angle of the upstream wind turbine and the obtained yaw constraint; and ΔPᵤₚ is the power change value of the upstream wind turbine.

Preferably, the based on a pattern search method, determining a cooperative operation optimization algorithm for the wind turbine groups according to the cooperative optimization problem model of the wind turbine groups, and optimizing the yaw angle of the wind turbines according to the cooperative operation optimization algorithm for the wind turbine groups, so as to achieve the maximum power generating capacity includes:

when performing collaborative optimization on the wind turbine groups, sorting the wind turbine groups according to the wind direction, dividing into optimized wind turbines T1-Tn, selecting upstream and downstream wind turbines Tᵢ and Tᵢ₊₁ in sequence, and optimizing the yaw angle of the upstream wind turbine through the pattern search method, thereby realizing the rolling optimization of the yaw angle of the wind turbine groups; the optimization steps of the pattern search method being as follows:
1) initializing the yaw angle of the upstream wind turbine as y₁, the initial step size as s, the direction coefficient α>1, the shortening factor β∈(0, 1), and the error as ε, and assuming x₁=y₁, k=1, j=1;
2) reading the simulation model information to calculate P_{farm}(yⱼ+αs), if P_{farm}(yⱼ+αs)>P_{farm}(yⱼ), assuming yⱼ₊₁=yⱼ+αs and xₖ=yⱼ₊₁, skipping to step 4); and if P_{farm}(yⱼ+αs)≤P_{farm}(yⱼ), skipping to step 3);
3) if P_{farm}(yⱼ−αs)>P_{farm}(yⱼ), assuming yⱼ₊₁=yⱼ−αs and xₖ=yⱼ₊₁; otherwise, assuming yⱼ₊₁=yⱼ, and skipping to step 4); and
4) if the step size s≤ε, exiting the calculation, and obtaining the optimal solution of the objective function; otherwise, assuming s=s*β, y₁=xₖ, k=k+1, j=1, and skipping to step 2).

In this embodiment, an offshore wind farm in East Chain is taken as an example to introduce the practical application process.
Step 1: a digital model of wind turbine groups is established, a wake influence matrix is established according to an improved Jensen wake model, and the wind turbine groups are divided; position information of wind turbines is substituted into the improved Jensen wake model, and a wake decay coefficient k is dynamically iterated according to the wind speed in front of the downstream wind turbine, thereby obtaining the wake radius of the upstream wind turbine at the downstream wind turbine; the wind turbine groups are divided according to the calculated wake radius and the position information of the wind turbine groups, a wake influence matrix is established for the wind turbines in the groups, and the degree of wake influence between wind turbine turbines is determined.
Step 2: the out-of-plane moment at the blade root, yaw bearing yaw moment and tower base pitching moment are selected to calculate an ultimate load of the wind turbines. The basic principle of Extrapolation is to use a direct integration method to obtain the ultimate load LT with the exceeding probability P_{T} as the target.

$${P}_{r} = P [ L > {L}_{T} ] = {\int }_{X} P [ L > {L}_{T} \vert X = x ] {f}_{x} ( x ) dx$$

In the formula, X is a multidimensional environmental variable. In the on-road wind turbines used in this model, only wind parameters are generally considered as main consideration factors; fₓ(x) is the joint probability distribution function for the distribution of multidimensional environmental variables; and T is the reproduction period.

Short-term load exceeding probabilities PT at different wind speeds are directly integrated to obtain a long-term load exceeding probability of the wind turbine. A wind speed interval required for a working condition DLC1.1 is divided into 11 sub-intervals in accordance with the resolution of 2 m/s according to the minimum standard required by IEC, with each sub-interval being a short-term operation interval with a time of 680 s, where the first 80 s as the start-up time of the wind turbines is ignored, and the last 600 s is regarded as an effective operation interval. Within each operation interval, yaw control is performed on the wind turbines at a speed below the rated wind speed, and yaw control and pitch angle control are performed at a speed above the rated wind speed.

According to the 20-year design service life of wind turbines, it can be concluded that during use, when T=20, there are a total of 1,051,200 sub-intervals with a time of 10 min, and the corresponding exceeding probability is 9.513e-7; and when T=1, there are a total of 52560 sub-intervals with a time of 10 min, and the corresponding exceeding probability is 1.903e-7. For each short-term 10 min simulation, the extreme values are taken in chunks, and each operation result is divided into 30 chunks by using the Gumbel distribution maximum likelihood method, so that an array M containing 330 maximum values can be obtained for 11 sub-intervals, the array M can be fitted by using Gumbel distribution, and then according to the exceeding probability of the wind turbine, the ultimate load under the recurrence of T years can be obtained.

$${f}_{x} ( x ) = \frac{\text{?}}{β} , z = \frac{x - μ}{β}$$

$$\text{?} \text{indicates text missing or illegible when filed}$$

In the formula, μ is the position coefficient; β is the scale coefficient; and x is the obtained ultimate load.

The above formula is the probability density function (PDF) of the Gumbel distribution. It is a relatively stable parameter estimation method to use the maximum likelihood method to process data for parameter confirmation of Gumbel. The log-likelihood function is:

$$L ( μ , β ; {X}_{i} , {X}_{2} … {X}_{n} ) = \frac{1}{{β}^{n}} \text{?}$$

$$ln L = - n ln β - \frac{1}{β} {\sum }_{i = 1}^{n} {x}_{i} + \frac{n μ}{β} - \text{?}$$

$$\text{?} \text{indicates text missing or illegible when filed}$$

The likelihood equation can be obtained as follows:

$$\frac{\partial ln L}{\partial μ} = N - \text{?} = 0$$

$$\frac{\partial ln L}{\partial μ} = - n β + {\sum }_{i = 1}^{n} {x}_{i} - n μ + μ e \text{?} = 0$$

$$\text{?} \text{indicates text missing or illegible when filed}$$

Sorting to obtain:

$$( \text{?} ) / ( \text{?} ) + β = \overline{X}$$

$$\text{?} \text{indicates text missing or illegible when filed}$$

β is obtained through a numerical method, and then the value of μ is solved, thereby obtaining the maximum likelihood estimates \hat{μ} [symbol] and \hat{β} [symbol] of the Gumbel probability density function parameters μ and β. The exceeding probability expression is shown as follows.

$$F = {( 1 - \frac{1}{N} )}^{\frac{1}{30}}$$

In the formula, N is the number of simulation groups required for the recurrence period T.

The ultimate load L_{E} calculation equation of the model can be obtained:

$${L}_{E} = μ - βln ( - ln ( F ) )$$

By substituting the relevant parameters into the above equation, the ultimate load conditions of the three loads under the 20-year recurrence period and their corresponding simulated turbulent wind mean speed can be obtained.

According to the wind speed specified by IEC64100-1 DLC1.1, the cut-in and cut-out wind speeds are divided according to the resolution of 2 m/s, output files of the 11 sub-interval are used as the input files of Mextremes, and data of the out-of-plane moment, yaw bearing moment and tower base pitching moment are processed, thereby obtaining load analysis conditions.
Step 3: according to the provisions of IEC 61400-1 for load safety coefficients, for the operation condition corresponding to the working condition DLC1.1, the local load safety coefficient γf=1.25 under normal design conditions. For the ultimate load obtained through analysis of Extrapolation and Mextremes, the safe local load safety coefficient and the safety of actual operation are comprehensively considered, and in the process of yaw and pitch angle control of a wind farm, the numerical product of the ultimate load calculated by means of Extrapolation and the load safety coefficient is taken as the safe load constraint for the wind turbines during normal operations.

Under the working condition of IEC64100-1 DLC1.1, a starting yaw angle through the opposite wind direction is searched to obtain corresponding loads under different yaw angle and wind speed conditions, and a threshold value of the yaw angle is taken by using the safe load as a constraint condition to obtain the corresponding yaw angle constraint.
Step 4: a cooperative optimization problem model of the wind turbine groups is established, a model constraint condition is obtained according to the safe load constraint and yaw angle constraint, the established wake influence matrix is used to divide the wind turbine groups, and the wind turbines in the groups are numbered according to the order of wake influence, the upstream and downstream wind turbines Tᵢ and Tᵢ₊₁ (i=1, 2, . . . ,n-2) are selected in sequence, and the yaw angle of the upstream wind turbine is optimized through the pattern search method to obtain the real-time optimal yaw angle of the wind turbine groups, thereby achieving optimal wake management.

The present invention has the beneficial effects as follows:

By means of the cooperative operation optimization control method for wind turbine groups with both wake control and energy efficiency improvement proposed by the present invention, the Jensen wake model is improved to enhance the wake overlap area identification accuracy, a wake effect judgment mechanism based on an overlap area method is constructed to improve the wake identification efficiency, the control process of wind turbine operation is optimized by integrating a pitch angle gain scheduling control strategy and a full-working-condition variable speed torque partition control strategy, and the safety performance during wind turbine operation is improved by combining the safe load limits of the ultimate load. By means of the proposed collaborative optimization algorithm for the wind turbine groups, the power generating efficiency of the wind turbine groups can be effectively improved, and the power generating efficiency of the wind turbines can be effectively improved, thereby achieving balanced optimization of economic benefits, resource utilization and cost control.

Each embodiment in this specification is described in a progressive manner. Each embodiment focuses on the differences from other embodiments. The same and similar parts among all embodiments can be referred to each other.

Specific embodiments are used herein to illustrate the principle and implementation of the present invention. The above description of the embodiments is only used to help understand the method and core idea of the present invention. Meanwhile, for those of ordinary skill in the art, there will be changes in the specific implementation and application scope according to the idea of the present invention. In summary, the content of this description should not be interpreted as a limitation on the present invention.

1. A cooperative operation optimization control method for wind turbine groups, comprising:
establishing a digital model of wind turbine groups to be measured, establishing a wake influence matrix according to the digital model and an improved Jensen wake model, and dividing the wind turbine groups according to the wake influence matrix to obtain divided wind turbines;
performing multi-degree-of-freedom controller design on the wind turbines;
calculating an ultimate load of the wind turbines jointly by using two methods, i.e. Extrapolation and Mextremes, and constructing a safe load constraint and a yaw angle constraint for wind turbine operation in conjunction with a safe load coefficient;
establishing a collaborative optimization problem model of the wind turbine groups by taking the maximum generating power of the wind turbine groups as an optimization objective, a yaw angle of an upstream wind turbine as a decision variable, and the safe load constraint, the yaw angle constraint and a power change range of the upstream wind turbine as constraint conditions; and
based on a pattern search method, determining a cooperative operation optimization algorithm for the wind turbine groups according to the cooperative optimization problem model of the wind turbine groups, and optimizing the yaw angle of the wind turbines according to the cooperative operation optimization algorithm for the wind turbine groups, so as to achieve the maximum power generating capacity;
wherein the performing multi-degree-of-freedom controller design on the wind turbines comprises:
establishing a variable pitch controller through a gain scheduling control strategy;
designing a generator torque controller through a variable speed torque partition control strategy; and
controlling the wind turbines according to the variable pitch controller and the generator torque controller, the calculation formulae of the variable pitch controller being
$${K}_{P} = \frac{2 {I}_{Drivetrain} {Ω}_{0} {ζ}_{φ} {w}_{φ rt}}{{N}_{Gear} [ - \frac{\partial P}{\partial θ} ]} GK ( θ ) ;$$
$${K}_{I} = \frac{{I}_{Drivetrain} {Ω}_{0} \text{?}}{{N}_{Gear} [ - \frac{\partial P}{\partial θ} ]} GK ( θ ) ;$$
$$GK ( θ ) = \frac{1}{1 + \frac{θ}{{θ}_{K}}} ;$$
$$\text{?} \text{indicates text missing or illegible when filed}$$
where I_{Drivertrain} is the drive train inertia on a low-speed shaft; Ω₀ is the rated low-speed shaft rotating speed; ζ_{φ} is the damping ratio; W_{φn} is the natural frequency; N_{Gear} is the ratio of a high-speed gearbox to a low-speed gearbox; P is the mechanical power; θ is the total blade variable pitch angle of a full-span rotor; θ_{K} is the blade variable pitch angle; GK(θ) is the dimensionless gain correction factor; K_{P} is the proportional gain of the variable pitch controller; and K_{I} is the integral gain of the variable pitch controller:
a control region of the generator torque controller comprises a first region, a second region, a third region, a fourth region and a fifth region; the first region is a control region prior to cutting into the wind speed, where the generator torque is zero and no power is extracted from the wind; the second region is a start-up region and is a linear transition between the first region and the third region; the third region is a control region used to optimize power capture, where the generator torque is proportional to the square of the filtered generator speed to maintain a constant tip speed ratio; the fourth region is a linear transition between the third region and the fifth region, where a torque slope corresponds to the slope of an induction motor; and the generator power in the fifth region remains constant, and the generator torque is inversely proportional to the filtered generator rotating speed.

2. The cooperative operation optimization control method for wind turbine groups according to claim 1, wherein the establishing a digital model of wind turbine groups to be measured, establishing a wake influence matrix according to the digital model and an improved Jensen wake model, and dividing the wind turbine groups according to the wake influence matrix to obtain divided wind turbines comprises:
establishing the digital model according to the group information of the wind turbine groups to be measured;
based on Turbsim, determining relative position information of all wind turbines according to the digital model;
re-adjusting a wake decay constant in Jensen according to the wind speed of a downstream wind turbine that is actually measured to obtain the improved Jensen wake model, the calculation formula of the improved Jensen wake model being:
$$\text{?}$$
$$\text{?} \text{indicates text missing or illegible when filed}$$
where D_{W,n} is the wake diameter at a distance s times the wind rotor diameter downstream of a wind turbine n; k is the adjusted wake decay constant; D is the wind rotor diameter; uₙ is the wake wind speed at a distance s times the wind rotor diameter downstream of the wind turbine n; u₀ is the incoming wind speed at infinity; and C_{T,n} is a thrust coefficient of the wind turbine n;
inputting the relative position information into the improved Jensen wake model to obtain high-precision wind turbine group wake information;
obtaining a wake field effect determinant according to the high-precision wind turbine group wake information and blade radius information of upstream and downstream wind turbines, the wake field effect determinant being
$${w}_{ij} = \{ \begin{matrix}\frac{( \frac{π ( {ar}_{1}^{2} + θ {r}_{2}^{2}}{180} r , d sin α )}{π {r}_{2}^{3}} , & Wake overlap \\ 0 , & i - j \\ 0 , & No wake overlap\end{matrix} ;$$
where wᵢⱼ is the degree of wake influence of a wind turbine i on a wind turbine j, r₁ is the wake radius, r₂ is the radius of the wind rotor of a downstream wind turbine, d is the distance from the center of the wake circle to the center of the wind rotor circle, α is the included angle between a connecting line between the point where a wake region and the wind rotor intersect and the center of the wake circle and d, and θ is the included angle between the connecting line between the point where the wake region and the wind rotor intersect and the center of the wind rotor circle and d; and
establishing a wake influence matrix of the wind turbine groups according to the wake field effect determinant, calculating the degree of wake effect influence of the wind turbine groups according to the wake influence matrix of the wind turbine groups, and dividing the wind turbine groups according to the degree of wake effect influence to obtain divided wind turbines.

3. (canceled)

4. The cooperative operation optimization control method for wind turbine groups according to claim 1, wherein the calculating an ultimate load of the wind turbines jointly by using two methods, i.e. Extrapolation and Mextremes, and constructing a safe load constraint and a yaw angle constraint for wind turbine operation in conjunction with a safe load coefficient comprises:
directly integrating short-term load exceeding probabilities at different wind speeds to obtain a long-term load exceeding probability of the wind turbines, dividing a wind speed interval of a preset working condition into multiple sub-intervals in accordance with the resolution of a preset speed according to a preset standard, and within each sub-interval, performing yaw control on the wind turbines at a speed below the rated wind speed, and performing yaw control and pitch angle control simultaneously on the wind turbines at a speed above the rated wind speed;
dividing operation data of the wind turbines into multiple working conditions according to the wind speed, performing multiple random simulations on each working condition under the same operation condition, and inputting each set of simulation data into Mextremes to obtain the ultimate load and corresponding wind speed;
determining the safe load constraint according to the values of the ultimate load and a preset local load safety coefficient; and
searching for a starting yaw angle through the opposite wind direction under a preset working condition to obtain corresponding loads of the wind turbines under different yaw angle and wind speed conditions, and taking a threshold value of the yaw angle using the safe load constraint to obtain the corresponding yaw angle constraint.

5. The cooperative operation optimization control method for wind turbine groups according to claim 1, wherein the expressions of the optimization objective and the constraints are:
Max P_{farm};
$$\{ \begin{matrix}{L}_{Root} < {L}_{Safe , r} \\ {L}_{Yaw} < {L}_{Safe , y} \\ {L}_{Twr} < {L}_{Safe , t} \\ {Y}_{c} < {Y}_{L} \\ △ {P}_{up} < 3 \%\end{matrix} ;$$
where P_{farm}and Pᵤₚ are the generating power of the wind turbine groups and the power of the upstream wind turbine, respectively; L_{Root}, L_{Yaw} and L_{Twr} are the wind turbine blade root out-of-plane moment, yaw bearing moment and tower base pitching moment, respectively; L_{Safe,r}, L_{Safe,y} and L_{Safe,t} are the obtained safe load limits, respectively; Y_{c} and Y_{L} are the real-time yaw angle of the upstream wind turbine and the obtained yaw constraint; and ΔPᵤₚ is the power change value of the upstream wind turbine.

6. The cooperative operation optimization control method for wind turbine groups according to claim 5, wherein the based on a pattern search method, determining a cooperative operation optimization algorithm for the wind turbine groups according to the cooperative optimization problem model of the wind turbine groups, and optimizing the yaw angle of the wind turbines according to the cooperative operation optimization algorithm for the wind turbine groups, so as to achieve the maximum power generating capacity comprises:
when performing collaborative optimization on the wind turbine groups, sorting the wind turbine groups according to the wind direction, dividing into optimized wind turbines T₁-Tₙ, selecting upstream and downstream wind turbines Tᵢ and Tᵢ₊₁ in sequence, and optimizing the yaw angle of the upstream wind turbine through the pattern search method, thereby realizing the rolling optimization of the yaw angle of the wind turbine group; the optimization steps of the pattern search method being as follows:
1) initializing the yaw angle of the upstream wind turbine as y₁, the initial step size as s, the direction coefficient α>1, the shortening factor β∈(0, 1), and the error as ε, and assuming x₁=y₁, k=1, j=1;
2) reading the simulation model information to calculate P_{farm}(yⱼ+αs), if P_{farm}(yⱼ+αs)>P_{farm}(yⱼ), assuming yⱼ₊₁=yⱼ+αs and xₖ=yⱼ₊₁, skipping to step 4); and if _{Pfarm}(yⱼ+αs)≤P_{farm}(yⱼ), skipping to step 3);
3) if P_{farm}(yⱼ−αs)>P_{farm}(yⱼ), assuming yⱼ₊₁=yⱼ−αs and xₖ=yⱼ₊₁; otherwise, assuming yⱼ₊₁=yⱼ, and skipping to step 4); and
4) if the step size s≤ε, exiting the calculation, and obtaining the optimal solution of the objective function; otherwise, assuming s=s*β, y₁=xₖ, k=k+1, j=1, and skipping to step 2).
